(19) United States
(12) Patent Application Publication
(10) Pub. No.: US 2007/0266090 A1
(43) Pub. Date: Nov. 15, 2007

(54) Emoticons in short messages

(75) Inventor: Omer Len, Ramat-Gan (IL)

Correspondence Address: SUGHRUE MION, PLLC, 2100 PENNSYLVANIA AVENUE, N.W., SUITE 800, WASHINGTON, DC, 20037, US

(73) Assignee: COMVERSE, LTD.

(21) Appl. No.: 11/401,417

(22) Filed: Apr. 11, 2006

(51) Int. Cl. G06F 15/16

(52) U.S. Cl. 709/204

(57) ABSTRACT

An apparatus for insertion of graphical items into a text message sent from a first telephony user to a second telephony user through a telephony network, including: a receiver, deployed in the network, configured to receive the text message from the first telephony user, a graphical enhancer, associated with the receiver, configured to graphically enhance text of the text message by replacing a predefined character string in the text with a respective predefined graphical item from a graphical item repository, and a forwarder, associated with the graphical enhancer, configured to forward the graphically enhanced text in a message to the second telephony user.

### FIELD AND BACKGROUND OF THE INVENTION

The present invention relates to short messages and more particularly but not exclusively to a method and an apparatus for inserting emoticons into short messages.

Short messaging has become extremely widespread and popular among cellular telephone users.

Short Message Service (SMS) is a service available on most digital mobile phones that permits the sending of short messages (also known as text messages, messages, or more colloquially SMS's, texts or even txts) between mobile phones, other handheld devices, and even landline phones.

Short messaging has developed very rapidly throughout the world. By mid-2004 text messages were being sent at a rate of 500 billion messages per annum, at an average cost of USD 0.10 per message. The sent text messages generate revenues in excess of USD 50 billion for mobile telephone operators, and represent about 100 text messages for every person in the world.

Growth in SMS usage has been rapid. For example, 250 billion short messages were sent in 2001 whereas just 17 billion were sent in 2000. SMS is particularly popular in Europe, Asia, and Australia (In Japan and Korea other cellular short messaging services such as i-mode are used.).

SMS popularity has grown to a sufficient extent that the term texting (used as a verb meaning the act of mobile phone users sending short messages back and forth) has entered the common lexicon.

In China, SMS is very popular, and has brought service providers large profits (only 18 billion short messages were sent in China in 2001).

However, SMS has limited message length, limited size, and the limited user interface of the mobile telephone handset.

Because of these limitations, users commonly make extensive use of abbreviations—particularly the use of numbers for words (for example, “4” in place of the word “for”), the omission of vowels (for example, “txt msg”), or the replacement of spaces with capitalization, such as “ThisIsVeryCool”.

However, cellular users need a method which enables a personal expression of thoughts and emotions without consuming scarce SMS text length.

Several attempts at providing a method for expression of thoughts and emotions without composing long text messages have been made.

U.S. Pat. No. 6,826,417, to Seignol, entitled “Process for sending images to a low display ability terminal”, filed on Nov. 16, 2001, introduces a method for transmitting drawings or images comprising text to low displayability terminals, such as a cellular handset.

U.S. Pat. No. 6,876,728 to Kredo, filed on Jul. 2, 2001, entitled “Instant messaging using a wireless interface”, allows telephony users and on-line users to communicate with one another using an instant messaging (IM) service. The on-line user may provide and receive textual messages, wherein the telephony user may provide and receive corresponding audible messages. These messages may convey emotion using associated emotional indicia, such as emoticons, or other emotional indicia, including the use of capitalization, emphasis, and the like. Emotional indicia provided in the text messages from the on-line user are audibly conveyed to the telephony user. Similarly, emotional indicia provided by the telephony user in the form of actual emotions or commands are provided in text to the on-line user.

US Patent Application No. 2004/0018858, to Nelson, entitled “Emoticon input method and apparatus”, filed on Aug. 17, 2001, provides a user with an emoticon input logic associated with an input key to improve the ease-of-use of an apparatus, such as a communication device, for entering emoticons into a text message, while the apparatus is operating, e.g. in a text mode.

US Patent Application No. 2004/0085259, to Tarlton, entitled “Avatar control using a communication device”, filed on Nov. 4, 2002, relates generally to communications and more specifically to providing messages during communications, for example in a wireless communication device with avatar control.

US Patent Application No. 2005/0027525, to Funakura, entitled “Cell phone having an information-converting function”, filed on Jul. 27, 2004, discloses a cell phone in which character information converted by means of voice recognition has improved expressiveness.

US Patent Application No. 2005/0100147, to Naick, entitled “Text messaging without a keyboard”, filed on Nov. 6, 2003, shows a way for text messaging without a keyboard. The way may include displaying a character on a display in response to engagement of a key based upon the associating characters, wherein the engagement of a key is concurrent with the exertion on the button.

US Patent Application No. 2005/0143102, to McEvilly, entitled “Method and system for user-definable fun messaging”, filed on Dec. 29, 2003, describes a method and an apparatus for encoding and decoding a message encoded with at least one entertainment component after receiving the message contents from a sender. With McEvilly, the purpose of the encoding is to transform or otherwise modify the message so that the sender and the recipient are able to enjoy an amusing or diverting interaction with the message behind the simple content the message bears.

US Patent Application No. 2005/0160149, to Durand, entitled “Linking sounds and emoticons”, filed on Jan. 21, 2004, introduces a method and an apparatus for linking sounds and emoticons to allow a message bearing an emoticon and audio signals associated with the emoticon.

US Patent Application No. 2002/0077135, to Hyon, entitled “Emoticon input method for mobile terminal”, filed on Nov. 15, 2001, discloses a method where a user of a mobile terminal may select and insert an emoticon, pre-stored on the mobile terminal, into a short message. However, the emoticon insertion results in significant length and size consumption for the resource limited SMS sent from the user's mobile terminal to the cellular telephony provider.

None of the patent applications cited above provides a method where a user may create a graphical personal expression of thoughts and emotions without consuming scarce SMS text message length and other scarce resources on his mobile terminal, such as when sending an SMS text message from his mobile cellular unit.

There is thus a widely recognized need for, and it would be highly advantageous to have, a short messaging apparatus and method which are devoid of the above limitations.

### SUMMARY OF THE INVENTION

According to one exemplary embodiment of the present invention there is provided an apparatus for insertion of graphical items into a text message sent from a first telephony user to a second telephony user through a telephony network, comprising: a receiver, deployed in the network, configured to receive the text message from the first telephony user, a graphical enhancer, associated with the receiver, configured to graphically enhance text of the text message by replacing a predefined character string in the text with a respective predefined graphical item from a graphical item repository, and a forwarder, associated with the graphical enhancer, configured to forward the graphically enhanced text in a message to the second telephony user.

According to a second exemplary embodiment of the present invention there is provided a method for insertion of graphical items into a text message sent from a first telephony user to a second telephony user through a telephony network, comprising: receiving the text message from the first telephony user in the telephony network, graphically enhancing text of the text message by replacing a predefined character string in the text of the text message with a respective predefined graphical item from a graphical item repository, and forwarding the graphically enhanced text in a message to the second telephony user.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

Preferred embodiments are herein described, by way of example only, with reference to the accompanying drawings. With specific reference now to the drawings in detail, it is stressed that the particulars shown are by way of example and for purposes of illustrative discussion of the preferred embodiments only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a block diagram illustrating an apparatus for insertion of graphical items into text of a text message, according to an exemplary embodiment of the present invention.

FIG. 2 is a flowchart illustrating a method for insertion of graphical items into text of a text message, according to an exemplary embodiment of the present invention.

FIG. 3 is a simplified flowchart which illustrates a graphical enhancement scenario of text of a text message in a cellular network, according to an exemplary embodiment of the present invention.

FIG. 4 illustrates a 32 byte matrix representing a picture, according to a current cellular telephony standard.

FIG. 5 shows an exemplary user specific translation table, according to an exemplary embodiment of the present invention.

### DETAILED DESCRIPTION OF THE PREFERRED EMBODIMENTS

The present embodiments comprise an apparatus and a method for inserting graphical items into text messages, sent by a user of a telephony network to one or more receivers.

The principles and operation of an apparatus and a method according to the embodiments may be better understood with reference to the drawings and accompanying description.

According to an exemplary embodiment of the present invention, a user of a telephony network is able to incorporate one or more predefined character string(s) into a text message that he creates and sends through the telephony network, to one or more recipients(s).

In the message, as delivered by the telephony provider to the recipient(s) designated by the user, the character string is automatically replaced by a graphical item, thus graphically enhancing the text in the message. The graphical item may be, but is not limited to: an icon such as an emoticon—an icon bearing an expression of emotion (for example—a smiley expressing happiness), a picture, an animated image, etc. Optionally, the graphical items may be black and white, grayscale, or colored.

Embodiments of the invention provide a telephony network service which facilitates a user specific translation of text strings in text messages sent by the user to graphical items, according to a user specific translation as defined by the specific user. Preferably, the translation as defined by the specific user is centrally stored in the telephony network.

In an exemplary embodiment the user specific translation is recorded in a user specific translation table. The translation table is centrally stored in the telephony network, such as on a cellular network's Short Message Service Center (SMSC).

Based on the specific user defined translation, a string of characters in the text may be translated to a matching graphical item. When the user composes a text message, the user may insert the string of characters into a text message and send the message through the network to a recipient designated by the user.

Then, when the text message is received in the network, such as by the above mentioned SMSC, if the character string appears in the text of the message, the character string is replaced with its matching graphical item(s). The replacement of such character strings with graphical items produces a graphically enhanced text.

Finally, the graphically enhanced text is forwarded in a message to the user designated recipient.

Preferably, as a prerequisite, the user who sends the text message bearing the text to be graphically enhanced is registered to the service. More preferably, the user predefines the translation of character strings into graphical items, such as by using the graphical item table, as explained hereinabove.

Optionally, the user may be charged ad-hoc when he chooses to use the service, be automatically assigned to the service and is free of charge, or any other way the service operator chooses for billing the user.

Before explaining at least one exemplary embodiment in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

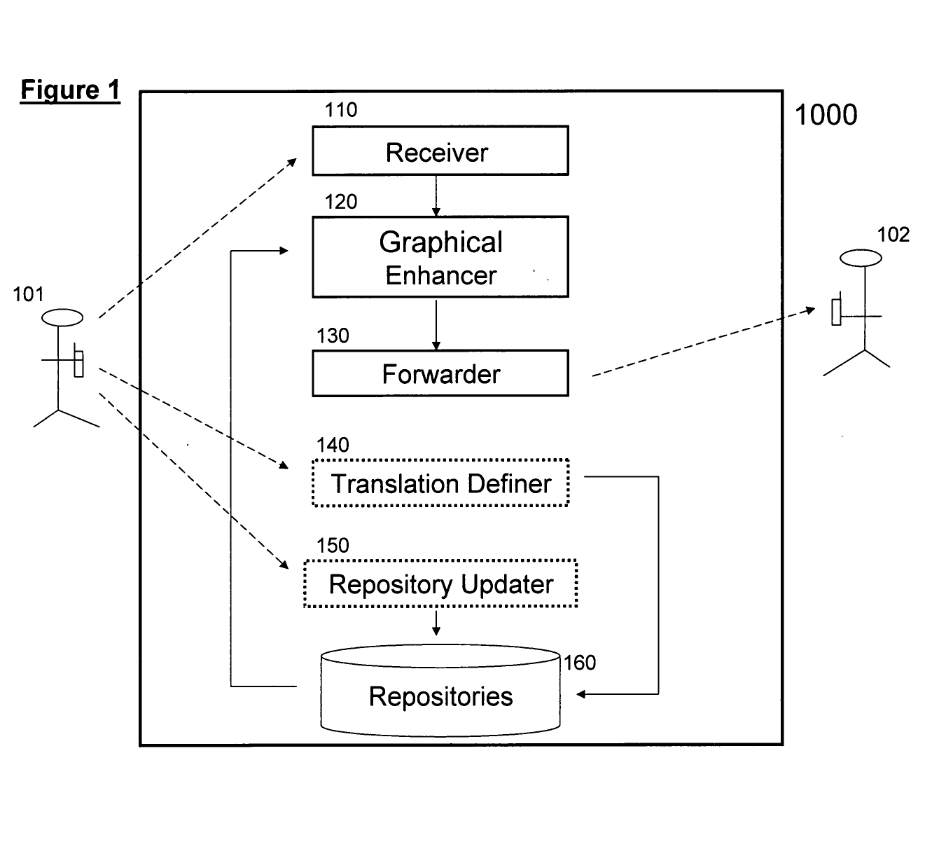

Reference is now made to FIG. 1, which is a block diagram illustrating an apparatus for insertion of graphical items into text of a text message, according to an exemplary embodiment.

Apparatus 1000 may be implemented in a telephony network, and includes a receiver 110, for receiving in the network a text message (for example—an SMS message) sent from a telephony user 101 of the telephony network to one 102 or more other telephony users.

The apparatus 1000 further includes a graphical enhancer 120, connected to the receiver 110. The graphical enhancer 120 is configured to graphically enhance the text in the user sent text message. The graphical enhancement includes replacing one or more predefined character string(s) in the text of the message with matching graphical item(s).

Preferably, the replacement is carried out by the graphical enhancer 120 according to a predefined translation between one or more character strings, and one or more graphical items, such that one or more graphical item(s) are mapped to each of the character string(s).

Optionally, the defined translation(s) and the graphical item(s) are stored in dedicated repositories 160 in the telephony network center. More preferably, there are provided user specific repositories. The user specific repositories may include user specific translation repositories holding user specific translations, as described in greater detail herein below.

Each character string includes one or more character(s). The graphical items may include, by are not limited to: an icon such as an emoticon—an icon bearing an expression of emotion (for example—a smiley expressing happiness), a picture, an animated images, etc.

The apparatus further includes a forwarder 130, configured to forward a text message carrying the graphically enhanced text to the recipient user 102 as designated by the user 101 in the text message received in the network.

According to an exemplary embodiment, a user of the telephony network defines a user specific translation of character strings to graphical items. Each user specific translation is used only when a text message sent by the specific telephony user to another user(s) is received in the network, as described in greater detail herein below. The service may optionally require subscription.

Preferably, the apparatus 1000 further includes a translation definer 140. The translation definer 140 may be used by the telephony user to define his own user specific translation for one or more specific character string(s) in text of text messages sent by the telephony user, as described hereinabove. The defined user specific translation may be recorded in a repository 160, as described hereinabove.

Preferably, the translation definer 140 may be operated by the user through a web site, such as the web site of the telephony network provider, so that the user can use a computer or like device to define strings for substitution. A computer has an interface which is easier to use than a mobile telephone and therefore the task of customizing the system is made easier.

More preferably, the translation definer 140 may be remotely operated by a client application running on a mobile unit used by the telephony user for communicating through the telephony network. For example, a cellular telephone used by a cellular telephony network may be installed with a client application, for remotely operating the translation definer 140, for defining the user's specific translation, as described hereinabove.

Preferably, the user specific translation may include a translation between a character string in the text of a text message sent by the specific user and a respective graphical item previously received by the specific user in a message sent through the telephony network.

The user specific translation is used for carrying out the replacement of character strings with graphical items, as described hereinabove. For example, a specific user of a cellular mobile unit may receive a graphically enhanced SMS message bearing an attractive smiley icon. The user may then be allowed to define his user-specific translation between a character string in text of a text message sent by the specific user and the smiley icon which the user received.

When the user sends an SMS bearing the character string, the character string is replaced by the smiley icon.

Optionally, the apparatus 1000 further includes a repository updater 150.

The repository updater 150 may be used by a user of the telephony network for adding new graphical items to the repositories 160 used by the apparatus 1000.

For example, the telephony user may utilize the repository updater 150 for updating a repository 160 with a graphical animated smiley image.

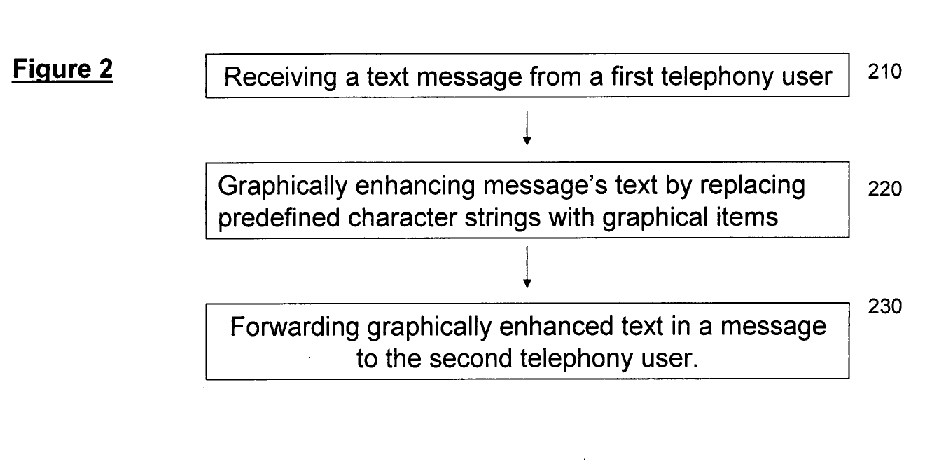

Reference is now made to FIG. 2, which is a flowchart illustrating a method for insertion of graphical items into text of a text message, according to an exemplary embodiment.

In a method according to an exemplary embodiment, a text message is received in operation 210 from a telephony network user, such as by the receiver 110, as described hereinabove.

Next, text in the user-sent text message is graphically enhanced in operation 220. The graphical enhancement includes replacing one or more predefined character string(s) in the text with matching graphical item(s), such as by the graphical enhancer 120 described hereinabove. Preferably, the replacement is carried out according to a predefined translation between one or more character strings, and one or more graphical items, such that one or more graphical item(s) replaces each of the character string(s). Optionally, the defined translation(s) and the graphical item(s) are stored in dedicated repositories 160 in the telephony network center.

Each character string includes one or more character(s). The graphical items may include, but are not limited to: an icon such as an emoticon—an icon bearing an expression of emotion (for example—a smiley expressing happiness), a picture, an animated image, etc.

Finally, a message bearing the graphically-enhanced text is forwarded in operation 230 to the recipient user, designated by the user in the text message received in the network. Optionally, the message bearing the graphically-enhanced text is forwarded by a forwarder 130, as described hereinabove.

The Short Message Service-Point to Point (SMS-PP) is defined in GSM Recommendation No. 03.40. The recommendation is different from GSM Recommendation No. 03.41 which defines the Short Message Service-Cell Broadcast (SMS-CB) allowing messages (advertising, public information, etc.) to be broadcast to all mobile users in a specified geographical area. These recommendations define protocols for SMS transmission and include protocols for inclusion of graphics in SMS messages, as described in greater detail herein below.

SMS Messages are sent via a store-and-forward mechanism to a Short Message Service Centre (SMSC). The SMSC attempts to send the message to the recipient. The SMSC may try to send the message if the user is not reachable at a given moment.

Known in the art SMS specification (TS 23040), section 3.10 (Enhanced Messaging Service) states that pictures can be incorporated in text messages. Current cellular handsets already implement the section.

As described hereinabove, a basic idea is to have a user-specific translation stored as a dedicated graphical item table for each user, inside the SMS center (SMSC) of a cellular telephony system. Each graphical item in the user specific translation is matched with a string of characters, which uniquely represents the graphical item when the specific user composes an SMS.

When a user composes an SMS, the user may insert the character string into the text of the SMS and send the message.

Then, when the SMS reaches the SMSC, the text in the SMS is graphically enhanced. In the graphical enhancement, the user-specific translation table is referenced and the string is replaced with its matching image. Finally, a message bearing the graphically enhanced text is transmitted to the recipient designated by the user in the SMS sent by the user.

Preferably, the user who sends the SMS is registered to the service, and his user specific translation table is predefined, such as by a translation definer 140, operated by the user via the service provider's website, as described hereinabove.

According to an exemplary embodiment, the apparatus 1000, when implemented in a cellular telephony network, has a minimal impact on current operation flow for transferring short messages in a cellular network.

In an exemplary embodiment, the visitor location register (VLR) of the cellular network, which is a local database maintained by the cellular network operator, for tracking visiting mobile units, is configured to check if a user who sends an SMS is registered to a graphical enhancement of a text messaging service. Furthermore, the SMS center (SMSC) is configured to perform the graphical enhancement of the text in the text message, as described in further detail hereinabove.

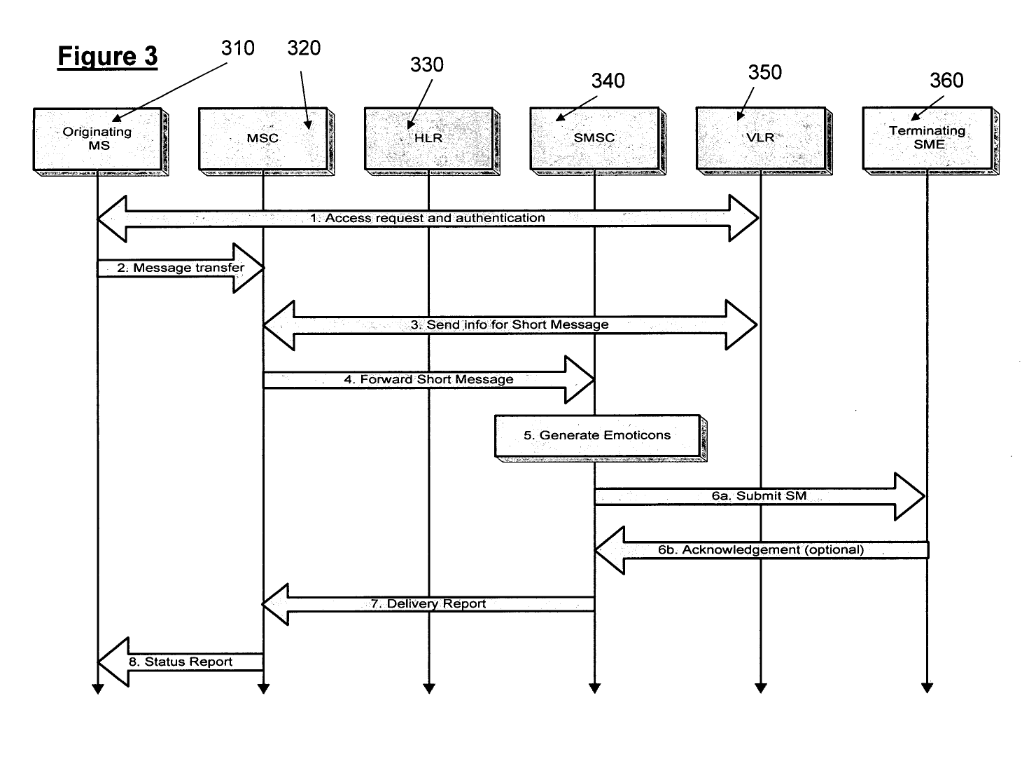

Reference is now made to FIG. 3 which is a simplified flow chart which illustrates graphical enhancement of a text message in a cellular network, according to an exemplary embodiment.

The exemplary scenario implements an emoticon service where a text message such as an SMS, sent by a specific user of a cellular telephony network, is graphically enhanced. In the scenario, the text message is graphically enhanced by inserting emoticons in place of character strings in the text message, as predefined by the specific user. The scenario includes the following operations:
1. The originating mobile station 310 (MS), is powered on and registered with the cellular telephony network.
2. The MS 310 sends the short message to a mobile switching center 320 (MSC).
3. The MSC 320 communicates with the visitor location register 350 (VLR), to verify that the message transfer does not violate network services invoked when the message is transferred or any restrictions that may have been imposed by the network operator, and checks whether the user is registered for the emoticons service.
4. The MSC 320 sends the short message to the SMSC 340 using the known in the art forward Short Message operation, including a flag indicating whether the user who sends the short message is registered to the emoticons service.
5. The SMSC 340 creates a new short message, in which all unique strings defined by the sending user are replaced by their matching emoticons, according to a translation predefined by the user, as explained in further detail herein below.
6. The SMSC 340 delivers a message bearing the graphically enhanced text to the recipient user's short message entity (SME) 360, for receiving and presenting the message, and optionally receives acknowledgment.
7. The SMSC 340 acknowledges to the MSC 320 the successful outcome of the forward Short Message operation.
8. The MSC 320 reports to the MS 310 the successful outcome of the operation.

In the exemplary scenario, upon receiving the short message, the SMSC 340 transfers the message to an Emoticons Generation Service (EGS). This service has access to a user specific translation as defined by the specific user who sends the short message.

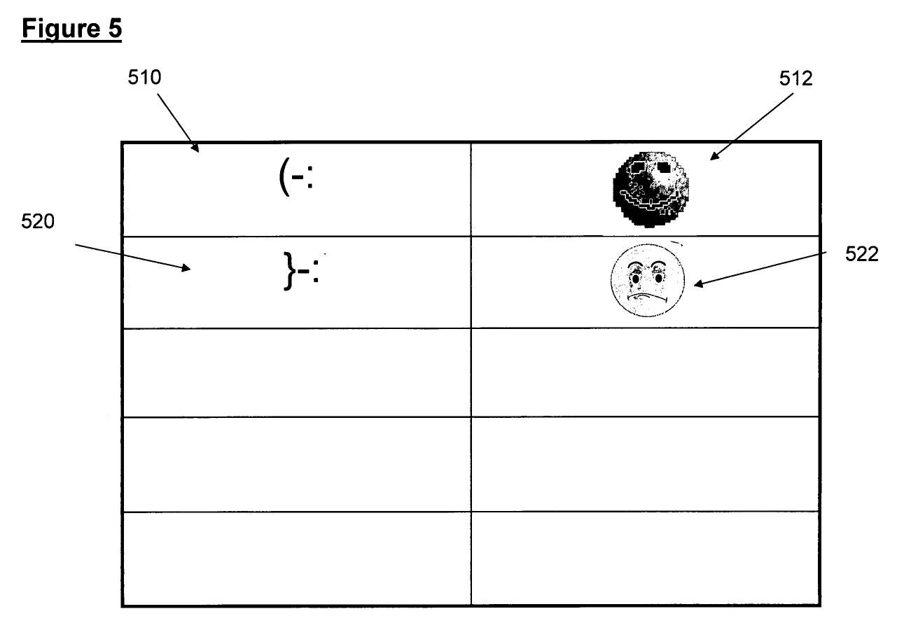

Preferably, the translation is recorded in a user specific translation table. The user-specific translation table holds reserved character-strings and matching images which are the emoticons of the scenario, as illustrated herein below, using FIG. 5.

In the exemplary scenario which is based on an exemplary embodiment, the EGS parses the short message. For parsing the message, the EGS searches the text of the short message for the strings defined by the user who sends the message and stored in the user-specific translation table, as described hereinabove.

After locating such strings, the EGS creates a copy of the current short message. In the copy, each of the string(s) is replaced by one or more graphical item(s) such as an emoticon, a picture, an animated image, or any other graphical item, according to the translation as predefined by the user.

The encoding of a graphical item in a short message may be carried out according to known in the art techniques. For example, such encoding is described in the SMS protocol standard for third generation cellular (3GL) networks (TS-230410), entitled “Technical realization of the Short Message Service” as described in greater detail herein below.

For example, the protocol standard defines that Information-Element-Data octets (an octet is an eight bit byte) are coded.

The first position of the octet (octet 1) indicates, in the short message (SM) data, the instant the picture is to be displayed. Octet 1 indicates the number of characters from the beginning of the SM data after which the picture is displayed. The first octet is coded as an integer value in the range 0 (beginning of the SM data) to the maximum number of characters included in the SM data of one single SM or one segment of a concatenated SM.

The octet's 2 to n positions contain any large picture, as described in further detail herein below.

The protocol standard further defines that pictures are coded from upper left to lower right. The protocol further defines that in each byte the most significant bit represent the pixel at the left.

In this standard, the pictures are plain black and white, no colors or grey scales are supported. The bit value 0 represents a white pixel and the bit value 1 represents a black pixel. However, other known in the art standards support encoding colored graphical items as well.

Thus, in order to implant an image in the text flow, the EGS simply indicates the offset in the text in which the image is to be displayed, according to the standard, as described hereinabove.

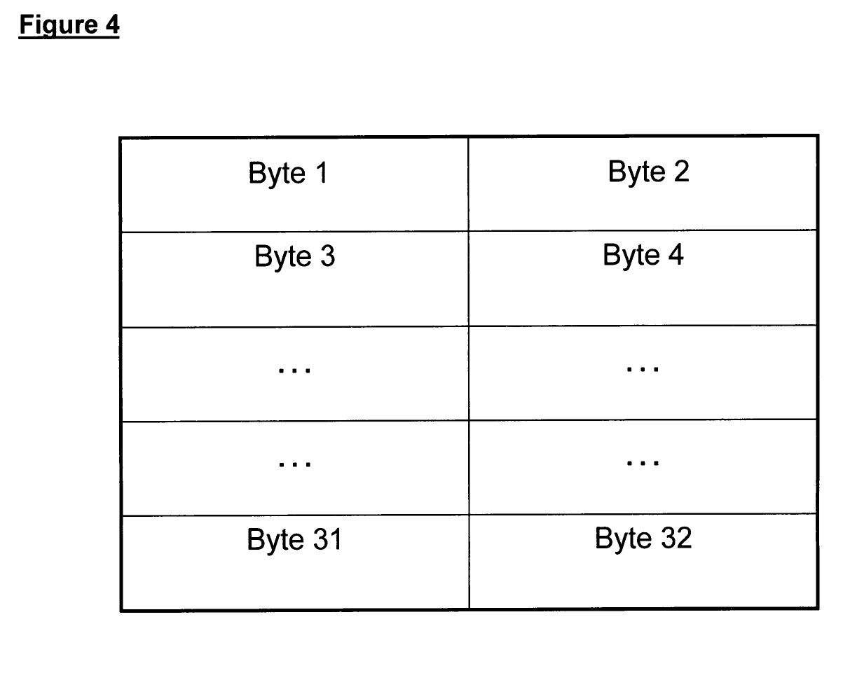

Reference is now made to FIG. 4 which illustrates a 32 byte matrix representing a picture, according to the standard described hereinabove.

An exemplary 16×16 bit picture representation according to the above described standard is represented in a matrix comprising 32 cells. Each cell holds a byte. Consequently the matrix holds 32 (bytes)×8 (bits per byte)=256 bits=16×16 bits. Each bit represents a single pixel in a picture inserted into the text of the text message.

As described hereinabove, a specific telephony user who chooses to subscribe to a service as provided using the methods described hereinabove predefines a translation of character strings to graphical items, to be applied to text messages sent by the specific user.

The translation provided by the user may be recorded in a dedicated storage space on the EGS. The dedicated storage space contains a user specific table of images/animations, and matching text-strings. Preferably, the user is allowed to create and update his user specific table using a translation definer 140, as described hereinabove. More preferably, the translation definer 140 may be operated by the user, using a dedicated web site, such as the Service Provider's website. The user may also be allowed to operate the repository updater 150, described hereinabove, using a web site.

Reference is now made to FIG. 5 which shows an exemplary user specific translation table, according to an exemplary embodiment.

In an exemplary user specific translation table, a telephony user defines that a first character string 510 is to be replaced by a smiley icon 512 when found in text messages sent by the specific user, whereas a second character string 520 is to be replaced by an animated crying image 522 when found in text messages sent by the specific user.

Optionally, the user is allowed to acquire (by purchasing or otherwise) images, and select a text-string that represents that image when the specific user composes and sends a text message such as an SMS.

According to an exemplary embodiment, there is provided dedicated client application, installed on a mobile unit of the user. The client application is configured to communicate with the translation definer 140, as described hereinabove.

It is expected that during the life of this patent many relevant devices and systems will be developed and the scope of the terms herein, particularly of the terms “SMS”, “Short message”, “Text message”, “Mobile unit”, “Web site”, “Client software”, “Icons”, “Animated images”, “Cellular”, and “Telephony”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An apparatus for insertion of at least one graphical item into a text message sent from a first telephony user to a second telephony user through a telephony network, comprising:
a receiver, deployed in the telephony network and configured to receive the text message from the first telephony user,
a graphical enhancer, associated with said receiver, configured to graphically enhance text of the received text message by replacing a predefined character string in the text with a respective predefined graphical item from a graphical item repository; and
a forwarder, associated with said graphical enhancer, configured to forward the graphically enhanced text in a message to the second telephony user.

2. The apparatus of claim 1, further comprising a translation definer, operable by a user of the telephony network for defining a user-specific translation between at least one character string in the text of the message sent by said user and a respective graphical item, wherein said replacing of the predefined character string is carried out according to said defined translation.

3. The apparatus of claim 2, wherein said translation definer is operable by said user for defining said user-specific translation through a web site.

4. The apparatus of claim 2, wherein said translation definer is further configured to be operated by a user client application running on a mobile unit, and usable by the user for remotely operating said translation definer.

5. The apparatus of claim 1, further comprising a graphical item repository updater, operable by a user of the telephony network, for adding a graphical item to said graphical item repository.

6. The apparatus of claim 5, wherein said graphical item repository updater is operable by said user, for adding said graphical item to said graphical item repository through a web site.

7. The apparatus of claim 5, wherein said item repository updater is further configured to be operated by a user client application running on a mobile unit, and usable by the user for remotely operating said item repository updater.

8. The apparatus of claim 2, wherein said translation definer is further operable by a user of the telephony network for defining a user-specific translation between at least one character string in a text of a text message sent by said user through the telephony network and a respective graphical item previously received by said user in a message sent through the telephony network, wherein said replacing of the predetermined character string is carried out according to said defined user-specific translation.

9. The apparatus of claim 1, wherein said graphical item is one of a group comprising: an icon, a picture, and an animated image.

10. The apparatus of claim 1, wherein said graphical item repository is a user-specific graphical item repository.

11. The apparatus of claim 1, wherein said character string consists of a single character.

12. A method for insertion of at least one graphical item into a text message sent from a first telephony user to a second telephony user telephony user through a telephony network, comprising:
receiving the text message from the first telephony user in the telephony network;
graphically enhancing text of the received text message by replacing a predefined character string in the text of the text message with a respective predefined graphical item from a graphical item repository; and
forwarding the graphically enhanced text in a message to the second telephony user.

13. The method of claim 12, further comprising allowing a user of the telephony network to define a user-specific translation between at least one character string in a text of a text message sent by said user and a respective graphical item, wherein said replacing of the predefined character string is carried out according to said defined user-specific translation.

14. The method of claim 13, further comprising allowing said user to define said user-specific translation using a web site.

15. The method of claim 13, further comprising allowing said user to define said translation using a user client application on a mobile unit.

16. The method of claim 12, further comprising allowing a user of the telephony network to add a graphical item to said graphical item repository.

17. The method of claim 16, further comprising allowing said user to add said graphical item to said graphical item repository using a web site.

18. The method of claim 16, further comprising allowing said user to add said graphical item to said graphical item repository using a user client application running on a mobile unit.

19. The method of claim 12, further comprising allowing a user of the telephony network to define a user-specific translation between at least one character string in a text of a text message sent by said user through the telephony system and a respective graphical item previously received by said user in a message sent through the telephony network, wherein said replacing of the predefined character string is carried out according to said defined translation.

20. The method of claim 12, wherein said graphical item is one of a group comprising: an icon, a picture, and an animated image.

21. The method of claim 12, wherein said graphical item repository is a user-specific graphical item repository.

22. The method of claim 12, wherein said character string consists of a single character.

23. The apparatus of claim 1, wherein the text message sent from the first telephony user includes text characters, but no graphical items.

24. The apparatus of claim 23, further comprising a translation definer for allowing the first telephony user to define the predetermined character string.

25. The method of claim 12, wherein the text message sent from the first telephony user includes text characters, but no graphical items.

26. The method of claim 25, wherein the predetermined character string is defined by the first telephony user.
